(19) United States
(12) Patent Application Publication
(10) Pub. No.: US 2025/0214864 A1
(43) Pub. Date: Jul. 3, 2025

(54) PARTICULATE INORGANIC MATERIAL EQUIPPED WITH ELEMENTAL SILVER AND ELEMENTAL RUTHENIUM

(71) Applicant: HERAEUS PRECIOUS METALS GMBH & CO. KG, Hanau (DE)

(72) Inventors: Milena KOVJENIC, Hanau (DE); Ana-Lucia MEZA-CHINCHA, Hanau (DE); Marie-Lena HARWARDT, Hanau (DE); Michael GOCK, Hanau (DE); Matthias HÖRTEIS, Hanau (DE)

(21) Appl. No.: 18/853,265

(22) PCT Filed: Feb. 3, 2023
(86) PCT No.: PCT/EP2023/052635

§ 371 Date: Oct. 1, 2024

(30) Foreign Application Priority Data
Apr. 6, 2022 (EP) 22166855.1

(51) Int. Cl. C01G 55/00; A01N 59/16; A01P 1/00

(52) U.S. Cl. CPC C01G 55/002; A01N 59/16; A01P 1/00; C01P 2004/61; C01P 2004/62; C01P 2004/64; C01P 2006/12

(57) ABSTRACT

A particulate inorganic material equipped with elemental silver and elemental ruthenium, said inorganic material having an average particle size (d50) in the range of 50 nm to 40 μm and a BET surface area in the range of 1 to 1600 m²/g. The inorganic material as such is selected from the group consisting of aluminum nitride, titanium nitride, silicon nitride, corundum, titanium dioxide in the form of anatase, titanium dioxide in the form of rutile, pyrogenic silica, precipitated silica, sodium aluminum silicate, zirconium silicate, zeolite, hydrotalcite and gamma-aluminum oxide hydroxide.

The invention relates to a particulate inorganic material equipped with elemental noble metal in the form of elemental silver and elemental ruthenium, and to two efficient processes for the preparation thereof.

WO 2021/084140 A2 discloses a process for preparing a particulate carrier material equipped with elemental silver and elemental ruthenium, which can be used as an additive for the antimicrobial treatment of a wide variety of materials and substances.

The object of the invention was to provide a highly antimicrobially active material based on a carrier material equipped with elemental silver and elemental ruthenium.

The object can be achieved by providing a product in the form of a particulate inorganic material equipped with elemental silver and elemental ruthenium, said inorganic material having an average particle size (d50) in the range of 50 nm to 40 μm and a BET surface area in the range of 1 to 1600 m²/g, wherein the inorganic material (the inorganic material as such) is selected from the group consisting of aluminum nitride, titanium nitride, silicon nitride, corundum (alpha-aluminum oxide), titanium dioxide in the form of anatase, titanium dioxide in the form of rutile, pyrogenic silica (pyrogenic silicon dioxide), precipitated silica (precipitated silicon dioxide), sodium aluminum silicate, zirconium silicate, zeolite, hydrotalcite and gamma-aluminum oxide hydroxide. The product according to the invention is hereinafter also referred to as “particulate inorganic material according to the invention equipped with elemental silver and elemental ruthenium.” Its silver-plus-ruthenium weight proportion formed by the elemental silver and the elemental ruthenium can, for example, be in the range of 0.1 to 50 wt. % (% by weight), preferably 1 to 40 wt. %, at a simultaneously prevailing silver:ruthenium weight ratio in the range of 1 to 2000 parts by weight of silver:1 part by weight of ruthenium, for example.

The particulate inorganic material or the particles of the inorganic material are a carrier material for the elemental silver and the elemental ruthenium, i.e., in the particulate inorganic material according to the invention equipped with elemental silver and elemental ruthenium, the particulate inorganic material functions as a carrier for the elemental silver and the elemental ruthenium. Usually and preferably, only one type of carrier material is present in the particulate inorganic material according to the invention equipped with elemental silver and elemental ruthenium.

The particulate inorganic material according to the invention equipped with elemental silver and elemental ruthenium comprises particles of inorganic material equipped with elemental silver and elemental ruthenium in a proportion, for example, in the range of 95 to 100 wt. %, in particular 100 wt. %. The possible proportion, not exceeding 5 wt. %, can be formed by corresponding inorganic particles free of noble metal. In other words, the particulate inorganic material according to the invention equipped with elemental silver and elemental ruthenium can consist of 95 to 100 wt. % of particles of inorganic material equipped with elemental silver and elemental ruthenium and 0 to 5 wt. % of corresponding inorganic particles free of noble metal, wherein the wt. % add up to 100 wt. %.

The term “average particle size” used herein means the volume-average primary particle diameter (d50) determinable by means of laser diffraction. In this case, what is known as Equivalent Circular Area Diameter (ECAD) can advantageously be used as a measure of the particle diameter (cf. RENLIANG XU ET AL: “Comparison of sizing small particles using different technologies,” POWDER TECHNOLOGY, ELSEVIER, BASEL (CH), vol. 132, no. 2-3, Jun. 24, 2003, pages 145-153). Laser diffraction measurements can be carried out using a corresponding particle size measuring instrument, for example a Mastersizer 3000 or Mastersizer 2000 from Malvern Instruments according to the wet determination process. In the wet determination process, a particulate sample can be dispersed in ethanol by means of ultrasound as part of the preparation of the sample.

The term “BET surface” used herein refers to the specific surface area that can be determined by means of BET measurement according to DIN ISO 9277: 2014-01 (according to chapter 6.3.1, static-volumetric measurement process, gas used: nitrogen).

The invention also relates to two processes for preparing such a particulate inorganic material according to the invention equipped with elemental silver and elemental ruthenium. From another perspective, the two processes can also be understood as processes for equipping corresponding particulate inorganic material with elemental silver and elemental ruthenium.

In the first process according to the invention, the particulate inorganic material according to the invention equipped with elemental silver and elemental ruthenium can be obtained by reducing at least one silver precursor and at least one ruthenium precursor in the presence of aqueously suspended particles of a corresponding inorganic material, then separating the solid formed in the process from the aqueous phase, optionally washing the separated solid with water and optionally drying the solid. The first process according to the invention therefore comprises the steps of: reducing at least one silver precursor and at least one ruthenium precursor in the presence of aqueously suspended particles of a corresponding inorganic material; separating the solid formed in the course of the reduction from the aqueous phase; optionally washing the separated solid with water; and optionally drying the separated and optionally washed solid. During the reduction, silver and ruthenium precursors can be reduced successively or preferably simultaneously.

The silver precursors and ruthenium precursors used in the first process according to the invention are silver and ruthenium compounds. Elemental silver or elemental ruthenium can be produced from the silver and ruthenium compounds, respectively, by reduction.

Examples of suitable silver compounds include silver acetate, silver sulfate and preferably silver nitrate.

Examples of suitable ruthenium compounds include ruthenium oxalate, ruthenium acetate and in particular ruthenium nitrosyl nitrate.

Particular preference is given to using a combination of silver nitrate and ruthenium nitrosyl nitrate as a combination of precursor compounds in the first process according to the invention.

The particles of an inorganic material used in the first process according to the invention are particles having an average particle size (d50) in the range of 50 nm to 40 μm and a BET surface area in the range of 1 to 2000 m²/g, the material of which as such is selected from the group consisting of aluminum nitride, titanium nitride, silicon nitride, corundum, titanium dioxide in the form of anatase, titanium dioxide in the form of rutile, pyrogenic silica (pyrogenic silicon dioxide), precipitated silica (precipitated silicon dioxide), sodium aluminum silicate, zirconium silicate, zeolite, hydrotalcite and gamma-aluminum oxide hydroxide. In other words, the particles consist of a material selected from the group consisting of aluminum nitride, titanium nitride, silicon nitride, corundum, anatase titanium dioxide, rutile titanium dioxide, pyrogenic silica, precipitated silica, sodium aluminum silicate, zirconium silicate, zeolite, hydrotalcite and gamma-aluminum hydroxide. Preference is given to corresponding particles of titanium nitride, corundum, titanium dioxide in the form of anatase or rutile, pyrogenic or precipitated silica and gamma-aluminum oxide hydroxide.

The reduction taking place in the first process according to the invention can be carried out at an alkaline pH in the range of 9 to 14, preferably 10 to 12, and at a suitable temperature with a reducing agent selected from the group consisting of sodium borohydride, hydrazine, hypophosphites and formates. Sodium borohydride or hydrazine, for example, can be conveniently worked with in the temperature range of 20 to 40° C.; hypophosphites or formates, for example, can be conveniently worked with in the temperature range of 60 to 90° C.

Hydrazine can be used as such, but preferably as hydrazine hydrate with a hydrazine content in the range of 30 to 65 wt. %. Hydrazine can also be used as a hydrazinium salt, for example as hydrazinium sulfate. Preference is given to working with hydrazine hydrate.

Hypophosphites and formates are mentioned herein. These are salts, in particular alkali metal salts, alkaline earth salts and ammonium salts (NH₄ salts). Preference is given to sodium hypophosphite and potassium hypophosphite or sodium formate and potassium formate.

In the first process according to the invention, the reducing agent(s) is/are used in a stoichiometrically required amount or more, but preferably in no more than 110% (hydrazine as the reducing agent) or in no more than 200% (sodium borohydride, hypophosphites or formates as the reducing agent) of the stoichiometrically required amount in order to completely reduce the silver and ruthenium precursors to elemental silver and elemental ruthenium. Explained using the example of hydrazine, this means that 1 mol of the reducing agent hydrazine can provide 4 mol of electrons with a reducing effect and accordingly releases 1 mol of N₂ in a reduction; accordingly, for example, the reduction of 1 mol of Ag⁺ requires 0.25 mol of hydrazine and the reduction of 1 mol of Ru³⁺ requires 0.75 mol of hydrazine.

Two embodiments of the first process according to the invention for preparing the particulate inorganic material according to the invention equipped with elemental silver and elemental ruthenium are disclosed below.

In a first embodiment, the first preparation process according to the invention comprises the successive steps of:
(1a) providing an aqueous suspension comprising water, particles of an inorganic material, at least one silver precursor and at least one ruthenium precursor,
(2a) bringing the aqueous suspension into contact with a reducing agent selected from the group consisting of sodium borohydride, hydrazine, hypophosphites and formates at an alkaline pH as mentioned above and at a suitable temperature as mentioned above,
(3) separating the formed solid from the aqueous phase,
(4) optionally washing the separated solid with water, and
(5) optionally drying the solid.

The sequence of steps (1a) to (5) relates to successive steps, and they can be directly successive steps without intermediate steps.

In step (1a) of the first embodiment of the first process according to the invention, an aqueous suspension comprising water, particles of an inorganic material, at least one silver precursor and at least one ruthenium precursor is provided.

The aqueous suspension can be prepared by adding particles of the inorganic material to an aqueous solution of the at least one silver precursor and of the at least one ruthenium precursor and suspending them therein.

However, it is preferred to work in such a way that silver precursors and ruthenium precursors, preferably in each case as an aqueous solution, are added simultaneously or in any order (overlapping with a time delay, alternating or successively) to an initially charged aqueous suspension of particles of the inorganic material. It is particularly preferred that an aqueous solution of both precursors (of the at least one silver precursor and of the at least one ruthenium precursor) is added to an initially charged aqueous suspension of particles of the inorganic material. In general, mixing is carried out during and also after the addition, for example by means of stirring. It may also be expedient to carry out mixing at a pH of the aqueous suspension that is in the pH range prevailing in the subsequent step (2a); for this purpose, a base, in particular alkali hydroxide, in particular sodium or potassium hydroxide, can be added to adjust the pH accordingly.

The weight proportion of the particles of the inorganic material of the aqueous suspension provided in step (1a) of the first embodiment of the first process according to the invention can be, for example, in the range of 5 to 30 wt. %.

The weight proportion of the noble metals formed from silver and ruthenium in the aqueous suspension provided in step (1a) of the first embodiment of the first process according to the invention can be, for example, in the range of 1 to 20 wt. %. The aqueous suspension provided in step (1a) of the first embodiment of the first process according to the invention is characterized by a weight ratio of the two noble metals, for example, in the range of 1 to 2000 parts by weight of silver:1 part by weight of ruthenium and generally significantly in favor of the silver.

In addition to the particles of the inorganic material and the noble metal precursors, the aqueous suspension provided in step (1a) of the first embodiment of the first process according to the invention generally only comprises water and optionally a base used for adjusting the pH.

In step (2a) of the first embodiment of the first process according to the invention, the aqueous suspension provided in step (1a) is brought into contact with a reducing agent selected from the group consisting of sodium borohydride, hydrazine, hypophosphites and formates at an alkaline pH as mentioned above and at a suitable temperature as mentioned above. If necessary, a corresponding pH and a corresponding temperature of the aqueous suspension can first be adjusted in this case. The alkaline pH can be adjusted using a base, in particular alkali hydroxide, especially sodium hydroxide or potassium hydroxide. The reducing agent is used, as mentioned above, in a stoichiometrically required amount or more for the complete reduction of the silver and ruthenium precursors to elemental silver and elemental ruthenium, respectively. Preference is given to working in such a way that the reducing agent is added to the aqueous suspension in the form of an aqueous solution. The addition is preferably carried out over a period of 10 to 60 minutes. It is advantageous to carry out mixing during and generally also after the addition, for example by means of stirring.

In a second embodiment, the first preparation process according to the invention comprises the successive steps of:
(1b) providing an aqueous alkaline suspension comprising water, particles of an inorganic material, a base and a reducing agent selected from the group consisting of sodium borohydride, hydrazine, hypophosphites and formates,
(2b) bringing the aqueous suspension into contact (i) with an aqueous solution comprising at least one silver precursor and at least one ruthenium precursor or (ii) with an aqueous solution comprising at least one silver precursor and then with an aqueous solution comprising at least one ruthenium precursor or (iii) with an aqueous solution comprising at least one ruthenium precursor and then with an aqueous solution comprising at least one silver precursor at an alkaline pH as mentioned above and at a suitable temperature as mentioned above,
(3) separating the formed solid from the aqueous phase,
(4) optionally washing the separated solid with water, and
(5) optionally drying the solid.

The sequence of steps (1b) to (5) relates to successive steps, and they can be directly successive steps without intermediate steps.

In step (1b) of the second embodiment of the first process according to the invention, an aqueous alkaline suspension comprising water, particles of an inorganic material, a base and a reducing agent selected from the group consisting of sodium borohydride, hydrazine, hypophosphites and formates is provided. The aqueous alkaline suspension can be prepared by adding particles of the inorganic material to an aqueous solution of the reducing agent and suspending them therein. However, preference is given to working in such a way that the reducing agent is added, preferably as an aqueous solution, to an initially charged aqueous suspension of particles of the inorganic material. The alkaline pH can be adjusted using a base, in particular with alkali hydroxide, especially sodium or potassium hydroxide, expediently in the pH range prevailing in the subsequent step (2b). It is advantageous to carry out mixing during and generally also after the addition, for example by means of stirring.

The weight proportion of the particles of the inorganic material in the aqueous suspension provided in step (1b) of the second embodiment of the first process according to the invention can be, for example, in the range of 5 to 30 wt. %.

The weight proportion of the reducing agent in the aqueous suspension provided in step (1b) of the second embodiment of the first process according to the invention can be, for example, in the range of 0.5 to 10 wt. %.

In addition to the particles of the inorganic material and the reducing agent, the aqueous suspension provided in step (1b) of the second embodiment of the first process according to the invention generally only comprises water and a base used for adjusting the pH.

In step (2b) of the second embodiment of the first process according to the invention, the aqueous suspension provided in step (1b) is brought into contact (i) with an aqueous solution comprising at least one silver precursor and at least one ruthenium precursor or (ii) with an aqueous solution comprising at least one silver precursor and then with an aqueous solution comprising at least one ruthenium precursor or (iii) with an aqueous solution comprising at least one ruthenium precursor and then with an aqueous solution comprising at least one silver precursor at an alkaline pH as mentioned above and at a suitable temperature as mentioned above. The single reducing agent is used, as mentioned above, in a stoichiometrically required amount or more for the complete reduction of the silver and ruthenium precursors to elemental silver and elemental ruthenium, respectively. Preference is given to working according to variant (i).

The weight proportion of the noble metals formed from silver and ruthenium in the aqueous suspension provided in step (1b) of the second embodiment of the first process according to the invention can be, for example, in the range of 1 to 20 wt. %. The aqueous suspension provided in step (1b) of the second embodiment of the first process according to the invention is characterized by a weight ratio of the two noble metals, for example, in the range of 1 to 2000 parts by weight of silver:1 part by weight of ruthenium and generally significantly in favor of the silver.

Mixing is expediently carried out during and generally also after the bringing into contact according to step (2b), for example by stirring, for example over a period of 1 to 2 hours.

Steps (3) to (5) are the same in both embodiments of the first process according to the invention.

In step (3), the solid formed in the respective steps (2a) or (2b) is separated from the aqueous phase. Examples of solid-liquid separation processes suitable for this purpose include processes known to a person skilled in the art such as decanting, pressing, filtering, suction filtration, centrifugation, or combinations thereof.

Step (4) of the first process according to the invention is an optional, but generally expedient step in which the solid separated in step (3) can be washed with water. Water-soluble constituents can be removed here. Washing can take place, for example, on a Nutsche filter.

Step (5) of the first process according to the invention is an optional, but generally expedient step in which the solid separated in step (3) and optionally washed in step (4) can be dried. In this case, water and any other volatile constituents present are removed from the solid obtained after completion of step (3) or step (4). The water can be removed in the sense of virtually complete water removal or in the sense of water removal until a desired residual moisture content is reached. For this purpose, most of the water can be removed by conventional processes, such as pressing, press filtration, suction filtration, centrifugation or similar processes, before drying, optionally supported by reduced pressure, is carried out at temperatures in the range of, for example, 20 to 150° C.

After completion of step (3) or optionally (4) or optionally (5) and optionally subsequent comminution and/or classification, the particulate inorganic material according to the invention equipped with elemental silver and elemental ruthenium is obtained. The silver and the ruthenium can be present on inner surfaces (within pores and/or cavities) and/or on the outer surface of the originally silver-free and ruthenium-free particles of the inorganic material, and can thereby form, for example, a discontinuous layer and/or small silver or ruthenium particles (silver or ruthenium islands). Scanning electron microscopy may be a suitable process for observing such morphological properties. The silver and the ruthenium are not alloyed, but are statistically distributed, and both noble metals are at least partially in contact with one another. It is clear to a person skilled in the art that the silver and the ruthenium can comprise other silver species than elemental metal silver and other ruthenium species than elemental metal ruthenium on the surface thereof-for example corresponding oxides, halogenides and/or sulfides. Such species can be formed during the performance of the first process according to the invention or thereafter, for example during storage, use or further processing of the particulate inorganic material according to the invention equipped with elemental silver and elemental ruthenium.

In the second process according to the invention, the particulate inorganic material according to the invention equipped with elemental silver and elemental ruthenium can be obtained by means of a thermolytic treatment under a reducing atmosphere of a previously dried preparation which, before drying, had comprised water, particles of a corresponding inorganic material, at least one silver precursor and at least one ruthenium precursor.

In the second process according to the invention, particles of an inorganic material, silver precursor and ruthenium precursor are used.

The silver precursors and the ruthenium precursors used in the second process according to the invention are silver and ruthenium compounds which can be thermally decomposed into elemental silver and elemental ruthenium, respectively, under a reducing atmosphere.

Examples of suitable silver compounds include silver acetate and preferably silver nitrate.

Examples of suitable ruthenium compounds include ruthenium oxalate, ruthenium acetate and in particular ruthenium nitrosyl nitrate.

Particular preference is given to using a combination of silver nitrate and ruthenium nitrosyl nitrate as a combination of precursor compounds in the second process according to the invention.

The particles of an inorganic material used in the second process according to the invention are particles having an average particle size (d50) in the range from 50 nm to 40 μm and a BET surface area in the range from 1 to 2000 m²/g, the material of which as such is selected from a material selected from the group consisting of aluminum nitride, titanium nitride, silicon nitride, corundum, titanium dioxide in the form of anatase, titanium dioxide in the form of rutile, pyrogenic silica, precipitated silica, sodium aluminum silicate, zirconium silicate, zeolite, hydrotalcite and gamma-aluminum oxide hydroxide. In other words, the particles consist of a material selected from the group consisting of aluminum nitride, titanium nitride, silicon nitride, corundum, anatase titanium dioxide, rutile titanium dioxide, pyrogenic silica, precipitated silica, sodium aluminum silicate, zirconium silicate, zeolite, hydrotalcite and gamma-aluminum hydroxide. Preference is given to corresponding particles of titanium nitride, corundum, titanium dioxide in the form of anatase or rutile, pyrogenic or precipitated silica and gamma-aluminum oxide hydroxide.

The second preparation process according to the invention comprises the successive steps of:
(1c) providing a preparation comprising water, particles of an inorganic material, at least one silver precursor and at least one ruthenium precursor,
(2c) drying the preparation provided in step (1c), and
(3c) thermolytically treating the dried preparation obtained after completion of step (2c) under a reducing atmosphere.

The sequence of steps (1c) to (3c) relates to successive steps, and they can be directly successive steps without intermediate steps.

In step (1c) of the second process according to the invention, a preparation is provided which comprises water, particles of an inorganic material, at least one silver precursor and at least one ruthenium precursor. The preparation may be in the form of an aqueous suspension or in the form of impregnated particles. The two forms (a) aqueous suspension versus (b) impregnated particles differ in the presence or absence of aqueous liquid between the particles; while in the case of an aqueous suspension there is an aqueous liquid between the particles, this is not the case with impregnated particles which have the appearance of a dry or freely flowable powder and the aqueous liquid forms a component of the particles or is within the particles.

The aqueous suspension can be prepared by adding particles of the inorganic material to an aqueous solution of the at least one silver precursor and of the at least one ruthenium precursor and suspending them therein.

However, it is preferred to work in such a way that silver precursors and ruthenium precursors, preferably in each case as an aqueous solution, are added simultaneously or in any order (overlapping with a time delay, alternating or successively) to an initially charged aqueous suspension of particles of the inorganic material. It is particularly preferred that an aqueous solution of both precursors (of the at least one silver precursor and of the at least one ruthenium precursor) is added to an initially charged aqueous suspension of particles of the inorganic material. In general, mixing is carried out during and also after the addition, for example by means of stirring.

The weight proportion of the particles of the inorganic material in the aqueous suspension provided in step (1c) of the second embodiment of the second process according to the invention can be, for example, in the range of 5 to 30 wt. %.

The weight proportion of noble metal formed from silver and ruthenium in the aqueous suspension provided in step (1c) of the second process according to the invention can be, for example, in the range of 1 to 20 wt. %. The aqueous suspension provided in step (1c) of the second process according to the invention is characterized by a weight ratio of the two noble metals for example in the range of 1 to 2000 parts by weight of silver:1 part by weight of ruthenium and generally significantly in favor of the silver.

In addition to the particles of the inorganic material and the noble metal precursors, the aqueous suspension provided in step (1c) of the second process according to the invention generally only comprises water and optionally a corresponding acid from the noble metal precursors.

Preparation in the form of impregnated particles is preferred. It can be carried out by impregnating the particles of the inorganic material with an aqueous solution of the at least one silver precursor and the at least one ruthenium precursor in a manner customary in the art. The impregnation process can be carried out once or repeatedly, in the latter case with a drying step taking place between the individual impregnation steps.

The impregnation process must be carried out in such a way that no aqueous suspension, i.e., neither a thin slurry nor a pulpy, pasty or doughy mass, is created, but rather impregnated particles are formed in the form of a macroscopically homogeneous and freely flowable powder. In other words, the volume of aqueous solution must be chosen to be sufficiently small and suitable for the particles of the inorganic material to be impregnated with it. When carrying out the impregnation, it is advantageous to allow sufficient time for the particles of the inorganic material and the aqueous solution to mix. For example, it may be appropriate to mix for a sufficiently long time, in particular until the said macroscopically homogeneous state of the mixed material is achieved. The volume of the aqueous solution can be selected by adjusting the respective concentration of the noble metal precursors to the amount of particles from the inorganic material to be brought into contact with it and their absorption behavior for the aqueous solution. If the volume is too large, the aforementioned undesirable slurries, pulps, doughs or pastes are created. A person skilled in the art can easily determine the absorption behavior of the relevant particles of an inorganic material for a relevant aqueous solution in orientating laboratory tests and thus determine the upper limit in liters of aqueous solution per kilogram of particles of the inorganic material without any loss of said free flowability occurring.

The weight proportion of the particles of the inorganic material in the impregnated particles provided in step (1c) of the second process according to the invention can be, for example, in the range of 50 to 90 wt. %.

The weight proportion of noble metal formed from silver and ruthenium in the impregnated particles provided in step (1c) of the second process according to the invention can be, for example, in the range of 3 to 15 wt. %. The impregnated particles provided in step (1c) of the second process according to the invention are characterized by a weight ratio of the two noble metals for example in the range of 1 to 2000 parts by weight of silver:1 part by weight of ruthenium and generally significantly in favor of the silver.

In addition to the particles of the inorganic material and the noble metal precursors, the impregnated particles provided in step (1c) of the second process according to the invention generally only comprise water and optionally a corresponding acid from the noble metal precursors. The water content of the impregnated particles provided in step (1c) of the second process according to the invention can, for example, be in the range of 7 to 35 wt. %.

In step (2c) of the second process according to the invention, the preparation provided in step (1c) is dried, i.e., freed from water and any other volatile substances present.

In the case of the aqueous suspension, it is evaporated to dryness. Advantageously, the aqueous suspension is agitated during concentration, for example by stirring and/or shaking and/or rotation, i.e., rotation of the vessel or container containing the aqueous suspension. In general, heating and/or negative pressure are applied during concentration to remove water and any other volatile substances that may be present. During concentration, work can be carried out at a temperature in the range of 40 to 95° C., for example. The material obtained after dryness has been achieved can be comminuted if necessary.

In the case of impregnated particles, these can be dried in an oven at a temperature in the range of 40 to 95° C., for example. Negative pressure can be applied to assist this. The dried material can be comminuted if necessary.

In step (3c) of the second process according to the invention, the noble metal precursors are thermally decomposed to form elemental silver and elemental ruthenium. For this purpose, the material obtained after completion of step (2c) and optionally comminuted is subjected to a thermolytic treatment under a reducing atmosphere. For this purpose, the material can be heated, either in stationary state or in motion, to an object temperature that ensures thermal decomposition of the noble metal precursors to form the respective elemental noble metal, for example in the range of 150 to 800° C., for example in a static furnace, a fluidized bed reactor or a rotary kiln.

The term “reducing atmosphere” as used herein refers to an atmosphere consisting of a gas comprising reducing properties, such as hydrogen, or a mixture of an inert gas such as nitrogen or argon with hydrogen, the latter with a volume fraction in particular in the range of 5 to 10 vol. %. During step (3c), the furnace chamber is expediently flushed with the gas comprising reducing properties; the gas flow can also serve to remove gaseous decomposition products.

After completion of step (3c) and optionally subsequent comminution and/or classification, the particulate inorganic material according to the invention containing elemental silver and elemental ruthenium is obtained. The silver and the ruthenium can be present on inner surfaces (within pores and/or cavities) and/or on the outer surface of the originally silver-free and ruthenium-free particles of the inorganic material, and can thereby form, for example, a discontinuous layer and/or small silver or ruthenium particles (silver or ruthenium islands). Scanning electron microscopy may be a suitable process for observing such morphological properties. The silver and the ruthenium are not alloyed, but are statistically distributed, and both noble metals are at least partially in contact with one another. It is clear to a person skilled in the art that the silver and the ruthenium can comprise other silver species than elemental metal silver and other ruthenium species than elemental metal ruthenium on the surface thereof for example corresponding oxides, halogenides and/or sulfides. Such species can be formed during the performance of the second process according to the invention or thereafter, for example during storage, use or further processing of the particulate inorganic material according to the invention equipped with elemental silver and elemental ruthenium.

Particulate inorganic material according to the invention equipped with elemental silver and elemental ruthenium is characterized by a dark or black color with a correspondingly low brightness L*, for example in the range of 35 to 45, which can be disturbing for some applications. The brightness L* is a specific* L* in the CIEL*a*b* color space (DIN EN ISO/CIE 11664-4: 2020-03) determined by spectrophotometry at a measurement geometry of d/8°; the spectrophotometric measurement of the particulate inorganic material according to the invention equipped with elemental silver and elemental ruthenium can be performed on a sample poured into a colorless glass vessel to a filling height of 1 cm through the flat glass bottom of the glass vessel placed on the measuring head of the spectral photometer used.

If desired, particulate inorganic material according to the invention equipped with elemental silver and elemental ruthenium can be further processed to form a brightened particulate material with a brightness L*, for example in the range of 50 to 85. For brightening purposes, the particulate inorganic material according to the invention equipped with elemental silver and elemental ruthenium can be brought into contact with at least one C1-C4 alkoxide of aluminum, magnesium, calcium, silicon, zinc, zirconium and/or titanium in the presence of an amount of water that is at least sufficient for complete hydrolysis of the at least one C1-C4 alkoxide. As stated, a brightened particulate material, i.e., a particulate material with a color, for example a gray color, with a brightness L* in the range of, for example, 50 to 85 can be formed. This brightened particulate material consists of the particulate inorganic material according to the invention equipped with elemental silver and elemental ruthenium with a solid located at least partially thereon. Depending on the selection of the at least one C1-C4 alkoxide, the solid is a solid selected from the group consisting of aluminum oxide, aluminum hydroxide, aluminum oxyhydroxide, magnesium oxide, magnesium hydroxide, magnesium oxyhydroxide, calcium oxide, calcium hydroxide, calcium oxyhydroxide, silicon dioxide, silica, zinc oxide, zinc hydroxide, zinc oxyhydroxide, zirconium dioxide, zirconium (IV) oxyhydrates, titanium dioxide, titanium (IV) oxyhydrates and combinations thereof.

The particulate inorganic material according to the invention equipped with elemental silver and elemental ruthenium, optionally brightened as mentioned above, is characterized by a particularly high antimicrobial effect, as can be determined in conventional inhibition zone tests or by determining the minimum inhibitory concentration from growth curves of microorganisms. In this respect, the invention also relates to the use of the optionally brightened particulate inorganic material according to the invention equipped with elemental silver and elemental ruthenium as an additive for the antimicrobial treatment of metal surfaces; coating agents such as varnishes and other paints; plasters; molding compounds; plastics materials in the form of plastics films, plastics parts, or plastics fibers; synthetic resin products; ion-exchange resins; silicone products; cellulose-based products; foams; cosmetics; and many others.

The particulate inorganic material according to the invention equipped with elemental silver and elemental ruthenium, optionally brightened as mentioned above, can also be used as a heterogeneous catalyst, for example in the catalysis of the formation of hydroxyl radicals in aqueous media permitting bacterial growth.

The particulate inorganic material according to the invention equipped with elemental silver and elemental ruthenium, optionally brightened as mentioned above, can be used in the aforementioned uses as a dry powder, as a powder with residual moisture or a desired moisture content or as an aqueous suspension.

### EXAMPLES

### Reference Example 1 (Reductive Preparation of a Cellulose Powder Equipped with 18.9 wt. % of Elemental Silver and 1.0 wt. % of Elemental Ruthenium)

75.6 g (445 mmol) of solid silver nitrate and 13.94 g of ruthenium nitrosyl nitrate solution (ruthenium content 19.0 wt. %; 26.2 mmol Ru) were dissolved in 416.8 g of deionized water, and the aqueous precursor solution obtained in this way was mixed homogeneously with 211.2 g of cellulose powder (Vitacel® L-600 from Rettenmaier und Sohne GmbH & Co KG) to form an orange, free-flowing impregnated particulate material. 705 mL of an aqueous hydrazine solution [4.19 g (131 mmol) of hydrazine and 81.81 g of a 32 wt. % sodium hydroxide solution (654.51 mmol NaOH), rest: water] with a pH of 13.9 were metered into the free-flowing impregnated particulate material at room temperature and a metering rate of 30 mL/min while stirring. Over time, a homogeneous pulp that became easier to stir was formed. After the metering ended, stirring was continued for 30 minutes until nitrogen release could no longer be observed. The material was then filtered off by means of suction, washed with a total of 1,000 mL of water, and dried in a drying cabinet at 105° C./300 mbar to a residual moisture content of 15 wt. %. A silver content of 18.9 wt. % and a ruthenium content of 1.0 wt. % of the end product (relative to 0 wt. % residual moisture) was determined by means of ICP-OES.

### Example 2 According to the Invention (Reductive Preparation of a Particulate Inorganic Material Equipped with 18.8 wt. % of Elemental Silver and 1.0 wt. % of Elemental Ruthenium)

An aqueous solution prepared from 52.5 g of aqueous silver nitrate solution (silver content 36.2 wt. %; 176 mmol Ag) and 5.4 g of aqueous ruthenium nitrosyl nitrate solution (ruthenium content 18.7 wt. %; 10 mmol Ru) was added to a suspension of 80 g of silicon dioxide (Aerosil® 150 from Evonik) in 1500 ml of water. This suspension was stirred at 80° C. for 7 hours. The suspension was then cooled to 30° C., a solution consisting of 2.6 g of hydrazine hydrate (hydrazine content 64 wt. %; 52 mmol), 32.2 g of sodium hydroxide solution (sodium hydroxide content 32%) and 250 ml of water was metered in over a period of 10 minutes and stirred for a further 5 hours. The material was then filtered off by means of suction, washed with a total of 5 L of water, dried in a drying cabinet at 105° C./300 mbar and ground with an agate mortar. A silver content of 18.8 wt. % and a ruthenium content of 1.0 wt. % of the product (relative to 0 wt. % residual moisture) was determined by means of ICP-OES.

### Example 3 According to the Invention (Thermolytic Preparation of a Particulate Inorganic Material Equipped with 18.3 wt. % of Elemental Silver and 0.8 wt. % of Elemental Ruthenium)

An aqueous solution prepared from 52.5 g of aqueous silver nitrate solution (silver content 36.2 wt. %; 176 mmol Ag) and 5.4 g of aqueous ruthenium nitrosyl nitrate solution (ruthenium content 18.7 wt. %; 10 mmol Ru) was added to a suspension of 80 g of silicon dioxide (Aerosil®) 150 from Evonik) in 1500 mL of water. This suspension was stirred at 80° C. for 7 hours. The material was then concentrated to dryness using a rotary evaporator (90° C./350 mbar). The dry material was then calcined in a tube furnace for 5 hours under a forming gas atmosphere (5 vol. % hydrogen/95 vol. % nitrogen) at 250° C. and comminuted with an agate mortar. A silver content of 18.3 wt. % and a ruthenium content of 0.8 wt. % of the product (relative to 0 wt. % residual moisture) was determined by means of ICP-OES.

### Example 4 According to the Invention (Thermolytic Preparation of a Particulate Inorganic Material Equipped with 18.0 wt. % of Elemental Silver and 1.0 wt. % of Elemental Ruthenium)

An aqueous solution prepared from 8.8 g of aqueous silver nitrate solution (silver content 36.2 wt. %; 29 mmol Ag) and 0.9 g of aqueous ruthenium nitrosyl nitrate solution (ruthenium content 18.7 wt. %; 1.7 mmol Ru) was added to 40 g of boehmite powder (Actilox® 200SM from Nabaltec) while shaking. The material was then dried in a drying oven at 105° C./300 mbar. This process was repeated three times until a total of 26.2 g of the aqueous silver nitrate solution (silver content 36.2 wt. %; 88 mmol Ag) and 2.7 g of the aqueous ruthenium nitrosyl nitrate solution (ruthenium content 18.7 wt. %; 5 mmol Ru) had been used. The material was then calcined in a tube furnace for 5 hours under a forming gas atmosphere (5 vol. % hydrogen/95 vol. % nitrogen) at 250° C. and comminuted with an agate mortar. A silver content of 18.0 wt. % and a ruthenium content of 1.0 wt. % of the product (relative to 0 wt. % residual moisture) was determined by means of ICP-OES.

### Example 5 (Test of the Products from Reference Example 1 and Examples 2 and 3 According to the Invention to Compare Their Antimicrobial Effect)

In separate Erlenmeyer flasks, 30 mL of a culture of methicillin-resistant Staphylococcus aureus(MRSA) in trypic soy broth (TSB) was adjusted to an optical density of 0.05. Different amounts of the product from Reference Example 1 in the range of 1 to 20 mg were then weighed in. The samples were incubated in a shaking incubator at 37° C. and 150 rpm. Within 6 hours, the optical density at a wavelength of 600 nm (OD600) was determined at hourly intervals. The inhibition of bacterial growth was indicated by a reduced increase in optical density compared to the control sample. An MRSA culture without the addition of an active antimicrobial substance served as the control sample. In the case of complete inhibition of bacterial growth, no increase in optical density was to be observed. The corresponding sample amount of the product from Reference Example 1 or Examples 2 to 4 according to the invention was used to calculate the minimum inhibitory concentration. This resulted in a minimum inhibitory concentration for the product from Reference Example 1 of 0.55 mg/mL and a comparatively lower minimum inhibitory concentration for the product from Example 2 according to the invention of 0.40 mg/mL, from Example 3 according to the invention of 0.40 mg/mL, and from Example 4 according to the invention of 0.35 mg/mL.

1. A particulate inorganic material equipped with elemental silver and elemental ruthenium, said inorganic material having an average particle size (d50) in the range of 50 nm to 40 μm and a BET surface area in the range of 1 to 1600 m²/g, wherein the inorganic material as such is selected from the group consisting of aluminum nitride, titanium nitride, silicon nitride, corundum, titanium dioxide in the form of anatase, titanium dioxide in the form of rutile, pyrogenic silica, precipitated silica, sodium aluminum silicate, zirconium silicate, zeolite, hydrotalcite and gamma-aluminum oxide hydroxide.

2. The particulate inorganic material equipped with elemental silver and elemental ruthenium according to claim 1 with a silver-plus-ruthenium weight proportion, formed by the elemental silver and the elemental ruthenium, in the range of 0.1 to 50 wt. % with a simultaneously prevailing silver:ruthenium weight ratio in the range of 1 to 2000 parts by weight of silver:1 part by weight of ruthenium.

3. A process for preparing a particulate inorganic material equipped with elemental silver and elemental ruthenium according to claim 1, comprising the steps of: reducing at least one silver precursor and at least one ruthenium precursor in the presence of aqueously suspended particles of a corresponding inorganic material; separating the solid formed in the course of the reduction from the aqueous phase; optionally washing the separated solid with water; and optionally drying the separated and optionally washed solid.

4. The process according to claim 3, wherein silver and ruthenium precursors are reduced successively or simultaneously.

5. The process according to claim 3, wherein the at least one silver precursor is selected from the group consisting of silver acetate, silver sulfate and silver nitrate, and wherein the at least one ruthenium precursor is selected from the group consisting of ruthenium oxalate, ruthenium acetate and ruthenium nitrosyl nitrate.

6. The process according to claim, wherein the particles of the inorganic material are particles having an average particle size (d50) in the range of 50 nm to 40 μm and a BET surface area in the range of 1 to 2000 m²/g of a material selected from the group consisting of aluminum nitride, titanium nitride, silicon nitride, corundum, titanium dioxide in the form of anatase, titanium dioxide in the form of rutile, pyrogenic silica, precipitated silica, sodium aluminum silicate, zirconium silicate, zeolite, hydrotalcite and gamma-aluminum oxide hydroxide.

7. The process according to claim 3, wherein the reduction is carried out at an alkaline pH in the range of 9 to 14 and at a temperature in the range of 20 to 40° C. with a reducing agent selected from the group consisting of sodium borohydride and hydrazine or at a temperature in the range of 60 to 90° C. with a reducing agent selected from the group consisting of hypophosphites and formates.

8. A process for preparing a particulate inorganic material equipped with elemental silver and elemental ruthenium according to claim 1, wherein a dried preparation which, prior to drying, had comprised water, particles of a corresponding inorganic material, at least one silver precursor and at least one ruthenium precursor is thermolytically treated under a reducing atmosphere.

9. The process according to claim 8, wherein the at least one silver precursor is selected from the group consisting of silver acetate, silver sulfate and silver nitrate, and wherein the at least one ruthenium precursor is selected from the group consisting of ruthenium oxalate, ruthenium acetate and ruthenium nitrosyl nitrate.

10. The process according to claim 8, wherein the particles of the inorganic material are particles having an average particle size (d50) in the range of 50 nm to 40 μm and a BET surface area in the range of 1 to 2000 m²/g of a material selected from the group consisting of aluminum nitride, titanium nitride, silicon nitride, corundum, titanium dioxide in the form of anatase, titanium dioxide in the form of rutile, pyrogenic silica, precipitated silica, sodium aluminum silicate, zirconium silicate, zeolite, hydrotalcite and gamma-aluminum oxide hydroxide.

11. The process according to claim 8, comprising the successive steps of:
(1c) providing a preparation comprising water, particles of the inorganic material, at least one silver precursor and at least one ruthenium precursor,
(2c) drying the preparation provided in step (1c), and
(3c) thermolytically treating the dried preparation obtained after completion of step (2c) under a reducing atmosphere.

12. The process according to claim 11, wherein the preparation provided in step (1c) is in the form of an aqueous suspension or in the form of impregnated particles.

13. The process according to claim 3, wherein the resulting particulate inorganic material equipped with elemental silver and elemental ruthenium is further processed to form a brightened particulate material having a brightness L* in the range of 50 to 85 by bringing it into contact with at least one C1-C4 alkoxide of aluminum, magnesium, calcium, silicon, zinc, zirconium and/or titanium in the presence of an amount of water that is at least sufficient for complete hydrolysis of the at least one C1-C4 alkoxide.

14. A use of the particulate inorganic material equipped with elemental silver and elemental ruthenium according to claim 1 or of a product prepared by a process for preparing the particulate inorganic material equipped with elemental silver and elemental ruthenium, comprising the steps of: reducing at least one silver precursor and at least one ruthenium precursor in the presence of: reducing at least one silver precursor and at least inorganic material; separating the solid formed in the course of the reduction from the aqueous phase; optionally washing the separated solid with water; and optionally drying the separated and optionally washed solid as an additive for the antimicrobial treatment of metal surfaces; coating agents; plasters; molding compounds; plastics in the form of plastics films, plastics parts or plastics fibers; textiles; textile applications; synthetic resin products; ion exchange resins; silicone products; cellulose-based products; foams; and cosmetics.

15. The use of the particulate inorganic material equipped with elemental silver and elemental ruthenium according to claim 1 or a product prepared by a process for preparing the particulate inorganic material equipped with elemental silver and elemental ruthenium, comprising the steps of: reducing at least one silver precursor and at least one ruthenium precursor in the presence of aqueously suspended particles of a corresponding inorganic material; separating the solid formed in the course of the reduction from the aqueous phase, optionally washing the separated solid with water; and optionally drying the separated and optionally washing solid as a heterogeneous catalyst in the catalysis of the formation of hydroxyl radicals in aqueous media permitting bacterial growth.
